(19) United States
(12) Patent Application Publication
(10) Pub. No.: US 2005/0205540 A1
(43) Pub. Date: Sep. 22, 2005

(54) Laser beam processing machine

(75) Inventor: Kentaro Iizuka, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/082,734

(22) Filed: Mar. 18, 2005

(30) Foreign Application Priority Data
Mar. 22, 2004 (JP) 2004-81855

(51) Int. Cl. B23K 26/00

(52) U.S. Cl. 219/121.83; 219/121.61

(57) ABSTRACT

A laser beam processing machine comprising a chuck table having a holding surface for holding a workpiece and a laser beam application means for applying a laser beam to the workpiece held on the chuck table, wherein the machine further comprises an output detector, installed adjacent to the chuck table, for detecting the output of a laser beam applied from the laser beam application means.

### FIELD OF THE INVENTION

The present invention relates to a laser beam processing machine for processing a workpiece held on a chuck table by a laser beam.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a circuit such as IC or LSI is formed in each of the sectioned areas. Individual semiconductor chips are manufactured by cutting this semiconductor wafer along the dividing lines to divide it into the areas having a circuit formed thereon. An optical device wafer comprising gallium nitride-based compound semiconductors and the like laminated on the front surface of a sapphire substrate is also cut along dividing lines to be divided into individual optical devices such as light-emitting diodes or laser diodes, which are widely used in electric equipment.

Cutting along the dividing lines of the above semiconductor wafer or optical device wafer is generally carried out by using a cutting machine called “dicer”. This cutting machine comprises a chuck table for holding a workpiece such as a semiconductor wafer or optical device wafer, a cutting means for cutting the workpiece held on the chuck table, and a cutting-feed means for moving the chuck table and the cutting means relative to each other. The cutting means has a spindle unit that comprises a rotary spindle, a cutting blade mounted on the spindle and a drive unit for rotary-driving the rotary spindle. The cutting blade is formed of a disk-like base and an annular cutting-edge which is mounted on the side wall outer peripheral portion of the base and formed as thick as about 20 μm by fixing diamond abrasive grains having a diameter of about 3 μm to the base by electroforming.

Since a sapphire substrate, silicon carbide substrate, etc. have high Mohs hardness, however, cutting with the above cutting blade is not always easy. Further, as the cutting blade has a thickness of about 20 μm, the dividing lines for sectioning devices must have a width of about 50 μm. Therefore, in the case of a device measuring about 300 μm×300 μm, the area ratio of the streets to the wafer becomes 14%, thereby reducing productivity.

Meanwhile, as a means of dividing a plate-like workpiece such as a semiconductor wafer, a laser processing method for applying a pulse laser beam capable of passing through the workpiece with its focusing point set to the inside of the area to be divided is also attempted nowadays. In the dividing method making use of this laser processing technique, the workpiece is divided by applying a pulse laser beam of a wavelength of, for example, 1,064 nm, which is capable of passing through the workpiece, from one side of the workpiece with its focusing point set to the inside to continuously form a deteriorated layer along the dividing lines in the inside of the workpiece and exerting external force along the dividing lines whose strength has been reduced by the formation of the deteriorated layers. This method is disclosed by Japanese Patent No. 3408805.

To improve the throughput of a circuit such as IC or LSI, a semiconductor wafer having a laminate of a low-dielectric insulating film (Low-k film) formed of a film of an inorganic material such as SiOF or BSG (SiOB) or a film of an organic material such as a polyimide-based or parylene-based polymer on the front surface of a semiconductor substrate such as a silicon wafer has recently been implemented. Since the Low-k film consists of multiple layers (5 to 15 layers) like mica and is extremely fragile, when the above semiconductor wafer having a Low-k film is cut along the dividing lines with a cutting blade, a problem occurs in that the Low-k film peels off and this peeling reaches the circuits and consequently, gives a fatal damage to the semiconductor chips.

To solve the above problem, JP-A 2003-320466 discloses a processing machine for removing the Low-k film by applying a pulse laser beam having a wavelength of, for example, 355 nm to the Low-k film formed on the dividing lines of the semiconductor wafer and cutting the semiconductor wafer along the dividing lines, from which the Low-k film has been removed, with a cutting blade.

Since the optimal output of a laser beam for the above-described laser processing differs according to the material of a workpiece, the output of laser beam application means must be adjusted according to the material of a workpiece before the start of laser processing. Therefore, even when the output of a laser beam has been adjusted, it is desired to check whether the output of a laser beam applied by the laser beam application means is the adjusted level or not. It is troublesome to carry an output detector for detecting the output of a laser beam applied from the laser beam application means to a laser beam processing machine in order to check the output of a laser beam applied from the laser beam application means each time the output of a laser beam is detected. Further, this detection work may be neglected by an operator.

### SUMMARY OF THE INVENTION

It is an object of the present invention to provide a laser beam processing machine which facilitates the checking of the output of a laser beam applied from the laser beam application means without carrying an output detector for detecting the output of a laser beam to the laser beam processing machine each time the output of a laser beam is detected.

According to the present invention, the above object can be attained by a laser beam processing machine comprising a chuck table having a holding surface for holding a workpiece and a laser beam application means for applying a laser beam to the workpiece held on the chuck table, wherein
the machine further comprises an output detector, which is installed adjacent to the chuck table and detects the output of a laser beam applied from the laser beam application means.

Preferably, the above output detector is so constituted to be allowed to be moved to a detection position above the holding surface of the chuck table and to a non-detection position below the holding surface of the chuck table.

Since the output detector for detecting the output of a laser beam applied from the laser beam application means is installed adjacent to the chuck table in the laser beam processing machine of the present invention, the output detector does not need to be carried to the laser beam processing machine each time the output of a laser beam applied from the laser beam application means is detected. Therefore, an operator's negligence of checking the output of a laser beam applied from the laser beam application means can be prevented.

### BRIEF DESCRIPTION OF THE DRAWINGS

FIG. 1 is a perspective view of a laser beam processing machine constituted according to the present invention;

FIG. 2 is a perspective view of the principal section showing a state where an output detector for detecting the output of a laser beam is installed on a chuck table mechanism provided in the laser beam processing machine shown in FIG. 1;

FIG. 3 is a perspective view showing a state where the output detector shown in FIG. 2 has been positioned to a detection position;

FIG. 4 is a block diagram schematically showing the constitution of laser beam processing means provided in the laser beam processing machine shown in FIG. 1; and

FIG. 5 is a diagram for explaining the focusing spot diameter of a laser beam applied from the laser beam processing means shown in FIG. 4.

### DETAILED DESCRIPTION OF THE PREFERRED EMBODIMENTS

Preferred embodiments of the present invention will be described in detail hereinunder with reference to the accompanying drawings.

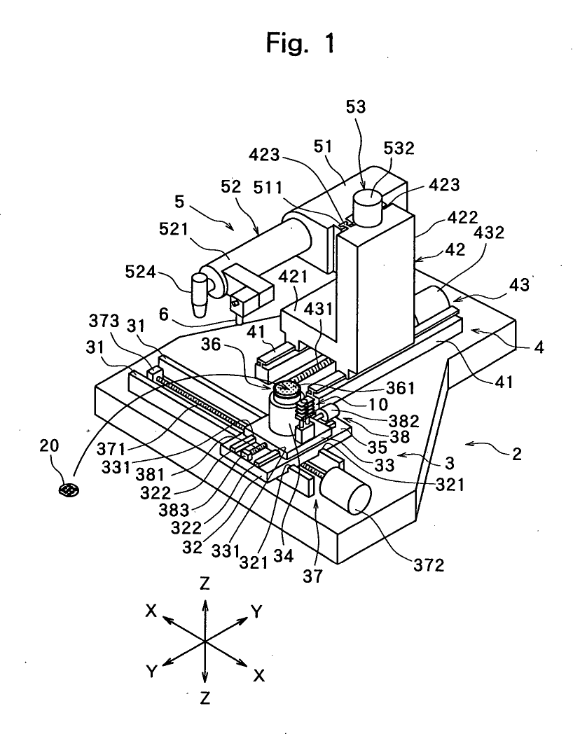

FIG. 1 is a perspective view of a laser beam processing machine constituted according to the present invention. The laser beam processing machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4 mounted on the stationary base 2 in such a manner that it can move in an indexing-feed direction indicated by an arrow Y perpendicular to the direction indicated by the arrow X, and a laser beam application unit 5 mounted on the laser beam application unit support mechanism 4 in such a manner that it can move in a direction indicated by an arrow Z.

The above chuck table mechanism 3 comprises a pair of guide rails 31 and 31 that are mounted on the stationary base 2 and arranged parallel to each other in the processing-feed direction indicated by the arrow X, a first sliding block 32 mounted on the guide rails 31 and 31 in such a manner that it can move in the processing-feed direction indicated by the arrow X, a second sliding block 33 mounted on the first sliding block 32 in such a manner that it can move in the indexing-feed direction indicated by the arrow Y, a support table 35 supported on the second sliding block 33 by a cylindrical member 34, and a chuck table 36 as a means for holding workpiece. This chuck table 36 has an adsorption chuck 361 made of a porous material such as a porous ceramic material or the like, and a disk-like semiconductor wafer as a workpiece is placed on the holding surface (top surface) of this adsorption chuck 361 and suction-held by activating a suction means that is not shown. The chuck table 36 is rotated by a pulse motor (not shown) installed in the cylindrical member 34 shown in FIG. 1.

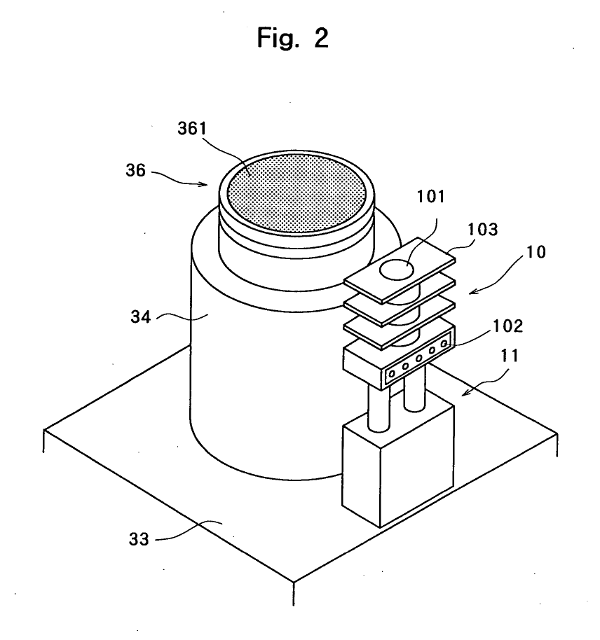

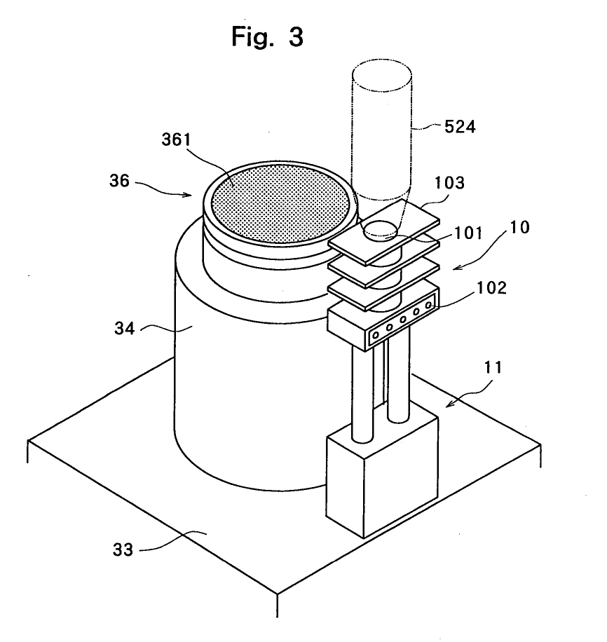

The laser beam processing machine in the illustrated embodiment is equipped with an output detector 10, installed adjacent to the above chuck table 36, for detecting the output of a laser beam applied from laser beam application means that will be described-later, of the above laser beam application unit 5. This output detector 10 may be POWER DETECTORS (trade name) which is marketed by GENTEC ELECTRO OPTICS INC. As shown in FIG. 2 and FIG. 3, the output detector 10 comprises a photodetecting portion 101 for receiving a laser beam and an indicator 102 for displaying the output value of the received laser beam in the upper portion. A cooling fin 103 is installed around the photodetecting portion 101. The output detector 10 constituted as described above is supported by a moving means 11 mounted on the above second sliding block 33. This moving means 11 is composed of an air cylinder, and is so constituted as to bring the output detector 10 to a non-detection position below the holding surface (top surface) of the adsorption chuck 361 as shown in FIG. 2 and to a detection position above the holding surface (top surface) of the adsorption chuck as shown in FIG. 3.

Continuing a description with reference to FIG. 1, the above first sliding block 32 has, on its undersurface, a pair of to-be-guided grooves 321 and 321 to be fitted to the above pair of guide rails 31 and 31 and has, on its top surface, a pair of guide rails 322 and 322 formed parallel to each other in the indexing-feed direction indicated by the arrow Y. The first sliding block 32 constituted as described above can move in the processing-feed direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment has a processing-feed means 37 for moving the first sliding block 32 along the pair of guide rails 31 and 31 in the processing-feed direction indicated by the arrow X. The processing-feed means 37 comprises a male screw rod 371 arranged between the above pair of guide rails 31 and 31 in parallel thereto, and a drive source such as a pulse motor 372 for rotary-driving the male screw rod 371. The male screw rod 371 is, at its one end, rotatably supported to a bearing block 373 fixed on the above stationary base 2 and is, at the other end, transmission-coupled to the output shaft of the above pulse motor 372. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-feed direction indicated by the arrow X.

The above second sliding block 33 has, on its undersurface, a pair of to-be-guided grooves 331 and 331 to be fitted to the pair of guide rails 322 and 322 formed on the top surface of the above first sliding block 32 and can move in the indexing-feed direction indicated by the arrow Y by fitting the guide grooves 331 and 331 to the pair of guide rails 322 and 322, respectively. The chuck table mechanism 3 in the illustrated embodiment has a first indexing-feed means 38 for moving the second sliding block 33 in the indexing-feed direction indicated by the arrow Y along the pair of guide rails 322 and 322 formed on the first sliding block 32. The first indexing-feed means 38 comprises a male screw rod 381, which is arranged between the above pair of guide rails 322 and 322 in parallel thereto, and a drive source such as a pulse motor 382 for rotary-driving the male screw rod 381. The male screw rod 381 is, at its one end, rotatably supported to a bearing block 383 fixed on the top surface of the above first sliding block 32 and is, at its other end, transmission-coupled to the output shaft of the above pulse motor 382. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 that are mounted on the stationary base 2 and are arranged parallel to each other in the indexing-feed direction indicated by the arrow Y and a movable support base 42 mounted on the guide rails 41 and 41 in such a manner that it can move in the indexing-feed direction indicated by the arrow Y. This movable support base 42 is composed of a movable support portion 421 movably mounted on the guide rails 41 and 41 and a mounting portion 422 mounted on the movable support portion 421. The mounting portion 422 is provided with a pair of guide rails 423 and 423 extending parallel to each other in the direction indicated by the arrow Z on one of its flanks. The laser beam application unit support mechanism 4 in the illustrated embodiment has a second indexing-feed means 43 for moving the movable support base 42 along the pair of guide rails 41 and 41 in the indexing-feed direction indicated by the arrow Y. This second indexing-feed means 43 comprises a male screw rod 431 that are arranged between the above pair of guide rails 41 and 41 parallel thereto, and a drive source such as a pulse motor 432 for rotary-driving the male screw rod 431. The male screw rod 431 is, at its one end, rotatably supported to a bearing block (not shown) fixed on the above stationary base 2 and is, at its other end, transmission-coupled of the above pulse motor 432. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment has a unit holder 51 and a laser beam application means 52 secured to the unit holder 51. In the unit holder 51, a pair of to-be-guided grooves 511 and 511 that are slidably fitted to the pair of guide rails 423 and 423 formed on the above mounting portion 422 are provided and supported in such a manner that it can move in the direction indicated by the arrow Z by fitting the to-be-guided grooves 511 and 511 to the above guide rails 423 and 423, respectively.

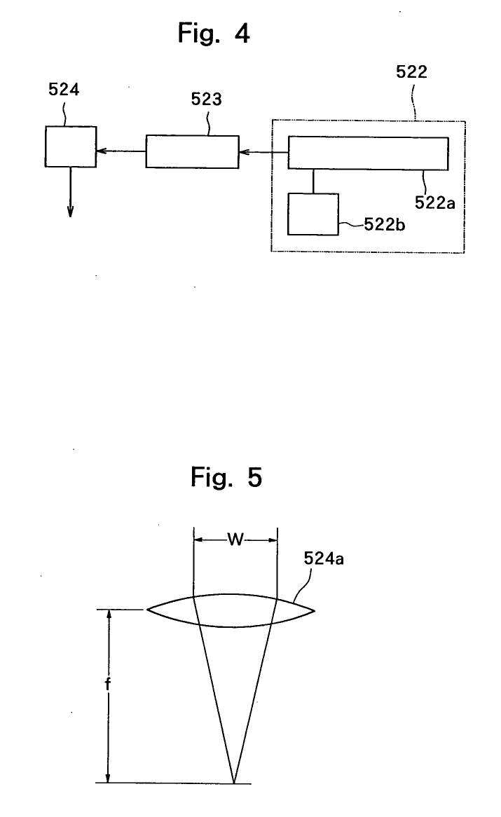

The illustrated laser beam application means 52 has a cylindrical casing 521 that is secured to the above unit holder 51 and extends substantially horizontally. In the casing 521, there are installed a pulse laser beam oscillation means 522 and a transmission optical system 523, as shown in FIG. 4. The pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 comprises suitable optical elements such as a beam splitter, etc. A condenser 524 housing condensing lenses (not shown) constituted by a set of lenses that may have a known formation is attached to the end of the above casing 521.

A laser beam oscillated from the above pulse laser beam oscillation means 522 reaches the condenser 524 through the transmission optical system 523 and is applied from the condenser 524 to the workpiece held on the above chuck table 36 at a predetermined focusing spot diameter D. This focusing spot diameter D is defined by the expression D (μm)=4×λ×f/(π×W) (wherein λ is the wavelength (μm) of the pulse laser beam, W is the diameter (mm) of the pulse laser beam applied to an objective lens 524a, and f is the focusing distance (mm) of the objective lens 524a) when the pulse laser beam having a Gaussian distribution is applied through the objective lens 524a of the condenser 524, as shown in FIG. 5.

Returning to FIG. 1, an image pick-up means 6 for detecting the area to be processed by the above laser beam application means 52 is installed to the front end of the casing 521 constituting the above laser beam application means 52. This image pick-up means 6 comprises an illuminating means for illuminating the workpiece, an optical system for capturing the area illuminated by the illuminating means, and an image pick-up device (CCD) for picking up an image captured by the optical system. An obtained image signal is transmitted to a control means that is not shown.

The laser beam application unit 5 in the illustrated embodiment has a moving means 53 for moving the unit holder 51 along the pair of guide rails 423 and 423 in the direction indicated by the arrow Z. The moving means 53 comprises a male screw rod (not shown) arranged between the pair of guide rails 423 and 423 and a drive source such as a pulse motor 532 for rotary-driving the male screw rod. By driving the male screw rod (not shown) in a normal direction or reverse direction with the pulse motor 532, the unit holder 51 and the laser beam application means 52 are moved along the guide rails 423 and 423 in the direction indicated by the arrow Z. In the illustrated embodiment, the laser beam application means 52 is designed to be moved up by driving the pulse motor 532 in a normal direction and to be moved down by driving the pulse motor 532 in the reverse direction.

A description is subsequently given of the operation of the laser beam processing machine in the illustrated embodiment, which is constituted as described above.

Before laser processing is carried out by using the above laser beam processing machine, an operator adjusts the output of a laser beam applied from the above laser beam application means 52 according to the material of the workpiece, the type of laser processing, etc. For instance, to carry out laser processing for removing the Low-k film formed on the dividing lines of the above semiconductor wafer by using a pulse laser beam (YAG laser, YOVO laser) having a wavelength of 355 nm, the average output of the laser beam is adjusted to a range of 0.3 to 4 W at a spot diameter of 9.2 μm, a repetition frequency of 50 to 100 kH and a processing-feed rate of 1 to 800 mm/sec. To carry out laser processing for forming a deteriorated layer in the inside of a silicon wafer along the dividing lines by using an LD excited Q switch Nd:YVO4 pulse laser having a wavelength of 1,064 nm, the average output of the laser beam is adjusted to a range of 0.5 to 2 W at a spot diameter of 1 μm, a repetition frequency of 100 kH and a processing-feed rate of 100 mm/sec.

The work of checking whether the output of a laser beam applied from the laser beam application means 52 whose output has been adjusted is the adjusted level or not is then carried out. The above output detector 10 is situated at the non-detection position shown in FIG. 2 when the output checking work is not carried out. For this output checking work, the chuck table 36 is moved to be brought to a position right below the condenser 524 of the laser beam application means 52. Thereafter, by activating the moving means 11 of the output detector 10, the output detector 10 is moved up to the detection position shown in FIG. 3. When a laser beam is applied from the laser beam application means 52 after the output detector 10 is thus positioned to the detection position, the laser beam is applied to the photodetecting portion 101 of the output detector 10 from the condenser 524. The output detector 10 whose photodetecting portion 101 has received the laser beam detects the output of the laser beam and displays the output value of the laser beam on an indicator 102 as a detection value. Therefore, the operator can check the output of the laser beam applied from the laser beam application means 52 by looking at the output value displayed on the indicator 102. When the output value displayed on the indicator 102 differs from the adjusted level, the operator re-adjusts the output of the laser beam. After the output checking work is carried out as described above, the moving means 11 of the output detector 10 is activated to move down the output detector 10 to the non-detection position shown in FIG. 2. After the output detector 10 is moved down to the non-detection position shown in FIG. 2, as the output detector 10 is positioned below the holding surface (top surface) of the adsorption chuck 361, even when the chuck table 36 is moved, it does not interfere with the condenser 524 of the laser beam application means 52, thereby making it possible to prevent the damage of the condenser 524 caused by interference. In the illustrated embodiment, the indicator 102 for displaying the output of a laser beam is provided in the output detector 10. However, the output detector may be connected to a monitor for an operator (not shown) to display the output value of the detected laser beam on the above monitor.

After the work of checking the output of the laser beam applied from the laser beam application means 52 is completed as described above, the predetermined laser processing work is carried out on the workpiece.

That is, the workpiece 20 such as a semiconductor wafer is placed on the adsorption chuck 361 of the chuck table 36 constituting the chuck table mechanism 3 of the laser beam processing machine shown in FIG. 1. By activating the suction means (not shown), the workpiece 20 is suction-held on the adsorption chuck 361. The chuck table 36 thus suction-holding the workpiece 20 is moved along the guide rails 31 and 31 by the operation of the feed means 37 to be brought to a position right below the image pick-up means 6 mounted on the laser beam application unit 5.

After the chuck table 36 is positioned right below the image pick-up means 6, alignment work for detecting a processing area to be processed by a laser beam of the workpiece 20 is carried out by the image pick-up means 6 and the control means that is not shown. That is, the image pick-up means 6 and the control means (not shown) carry out image processing such as pattern matching, etc. to align the processing area such as a dividing line formed on the workpiece 20 with the condenser 524 of the laser beam application unit 5 for applying a laser beam along the processing area, thereby performing the alignment of a laser beam application position.

After the processing area of the workpiece 20 held on the chuck table 36 is detected and the alignment of the laser beam application position is carried out as described above, the chuck table 36 is moved to bring one end of the workpiece 20 to a position right below the condenser 524 of the laser beam application means 52. The chuck table 36 is moved in the processing-feed direction at a predetermined processing-feed rate while a laser beam is applied from the condenser 524 of the laser beam application means 52. As a result, predetermined laser processing is carried out by the laser beam whose output has been adjusted as described above on the processing area of the workpiece 20.

1. A laser beam processing machine comprising a chuck table having a holding surface for holding a workpiece and a laser beam application means for applying a laser beam to the workpiece held on the chuck table, wherein
the machine further comprises an output detector, which is installed adjacent to the chuck table and detects the output of a laser beam applied from the laser beam application means.

2. The laser beam processing machine according to claim 1, wherein the output detector is so constituted to be allowed to be moved to a detection position above the holding surface of the chuck table and to a non-detection position below the holding surface of the chuck table.
